(19) United States
(12) Patent Application Publication
(10) Pub. No.: US 2004/0247496 A1
(43) Pub. Date: Dec. 9, 2004

(54) Vehicular photoelectron air purifier

(76) Inventor: Se Kit Yuen, Kowloon (HK)

Correspondence Address: Dr. Arthur King Ma, 1030 Coronado Drive, Arcadia, CA, 91007, US

(21) Appl. No.: 10/751,130

(22) Filed: Dec. 31, 2003

(30) Foreign Application Priority Data
Jun. 6, 2003 (CN) 03 2 62307.0
Jun. 6, 2003 (CN) 03 2 62308.9

(51) Int. Cl. B01J 19/08; B01J 19/12

(52) U.S. Cl. 422/186.3

(57) ABSTRACT

This invention relates to a vehicular photoelectron air purifier, and its body is a square-columnar structure comprises extractor fan, transformer, circuit board, and polarization end ultraviolet ray radiation tube. Said body is equipped with one air inlet and one air outlet; said air outlet locates at a front portion of said body and an air exhaust frame trellis device is provided above a front end surface of said body; said air inlet locates at a rear portion of said body and an air intake frame trellis device is provided at a rear portion of said body; said intake frame trellis device provided an air inlet that is used for fixing dustproof frame, dustproof net and dustproof cover; said extractor fan is kept close to the inner surface of said air exhaust frame trellis device, there is an air collector between said air inlet and said extractor fan; said polarization end ultraviolet ray radiation tube lies in s center portion of said air collector. Because of the outstanding effect of ultraviolet ray eliminating virus, bacillus and mildew, the air, under actions of said extractor fan, is forced to pass through around said ultraviolet light tube for purpose of eliminating virus, bacillus and mildew; because two extractor fans are arranged abreast along a linear direction of said polarization end ultraviolet ray tube, air flow increase in amount and treating capacity strengthens so as to sufficiently eliminate virus, bacillus and mildew contained in air.

### BACKGROUND OF THE PRESENT INVENTION

1. Field of the Present Invention

The present invention relates to a vehicular photoelectron air purifier, and more particularly, it relates to an air purifier which can eliminate virus, bacillus and mildew and etc. in the air through purifying the air by a polarization end ultraviolet ray, with a vehicular power supply besides the municipal power supply.

2. Description of Related Arts

Insufficient ventilation of indoor or an enclosed room readily makes the air dreggy and leads to the virus and bacillus propagated and spread. In a public and an air conditioning room, therefore, it is necessary to manually purify the air and eliminate virus and bacillus without delay for keeping fresh air in a given room or an area. In an air conditioning room during summer period, purification of indoor air is also a very important problem that is difficult to deal with. More and more attentions are drawn to indoor air purification due to wide diffusion of SARS virus. In a conventional method, an ultraviolet light for eliminating bacillus may cause injure by irradiating human body. In addition, the present conventional ventilating and air conditioning equipment have no air purifying function, which generally are equipped with simple deducting and filtering devices, and it is not cost effective to replace one during mass production. In addition, insufficient ventilation of car, train, airplane and ship department will also cause the same concerns as described and conventional methods are not sufficient to provide solution.

### SUMMARY OF THE PRESENT INVENTION

A main object of the present invention is to overcome the defects in the prior art, and to provide vehicular photoelectron air purifier for purifying the air with high efficiency through the ultraviolet and through such way as combing the ultraviolet and the negative ion by a power supply powered of transportation vehicles such as cars and ships.

Accordingly, a vehicular photoelectron air purifier is disclosed; a main body is a square-columnar structure comprises a plurality of extractor fan, a plurality of transformer, a plurality of circuit board, and a plurality of polarization end, a plurality of ultraviolet ray radiation tube. Said body is equipped with one air inlet and one air outlet; said air outlet locates at front portion of said body and an air exhaust frame trellis device is provided on a plane of a front end surface of said body; said air inlet locates at a rear portion of said body and said air intake frame trellis device is provided at said rear end of said body; said intake frame trellis device provides an air inlet and is used as a fixed dustproof frame, dustproof net and dustproof cover; said extractor fan is kept close to an inner surface of said air exhaust frame trellis device; there is an air collector between said air inlet and said extractor fan; said polarization end ultraviolet ray radiation tube lies in a center portion of said air collector.

According to another aspect of the present invention, a vehicular photoelectron air purifier is provided, a main body of which is a square-columnar structure comprising a plurality of extractor fan, a plurality of transformer, a plurality of circuit board, a plurality of polarization end ultraviolet ray radiation tube, and a plurality of cathodal high-voltage discharging carbonized fiber wire. Said body is equipped with one air inlet and one air outlet: An air exhaust frame trellis device with cambered surface structure is provided on a rear upper portion of said body; said outer frame trellis device is provided at a front portion of the body; said air intake frame trellis device is provided at a rear portion of said outer frame trellis device; said intake frame trellis device provides an air inlet and is used as a fixed dustproof frame, dustproof net and dustproof cover; said cathodal high-voltage discharging carbonized fiber wire is fixed in a center portion of a front surface of said an air exhaust frame trellis device; said polarization end ultraviolet ray radiation tube is mounted at said air outlet in said body and lies in said air collector; an extractor fan and an electric motor are kept close to an inner surface of said air intake frame trellis device.

Since ultraviolet has outstanding effect for eliminating virus, bacillus and mildew, the air, under actions of said extractor fan, is forced to pass through around said ultraviolet light tube for the purpose of eliminating virus, bacillus and mildew; because there are two extractor fans arranged abreast along a linear direction of said polarization end ultraviolet ray tube, the air flow increases in amount and treating capacity strengthens so as to sufficiently eliminate virus, bacillus and mildew in the air.

The present invention, employs said polarization end ultraviolet ray to eliminate virus, bacillus and mildew in air; meanwhile, said cathodal high-voltage discharging carbonized fiber wire can increase negative ions in the environment; when the air is drawn into said purifier by said fan, two continuously alternating working modes are available, i.e.; both said ultraviolet radiation and said high voltage ionization negative ion are automatically and alternatively operated so as to provide ideal air purifying effect. A sheltering wall and said air collector are provided around said polarization end ultraviolet ray radiation tube in said main body of the present invention, therefore, said ultraviolet ray shall not irradiate to outside of said main body and thus preventing eye injure of users from leakage of ultraviolet; said purifier of the present invention can use both the municipal power supply and any power supply of transportation vehicles, so it is convenient for carrying and using and applicable for various places.

### BRIEF DESCRIPTION OF THE DRAWINGS

FIG. 1 is a side view of the product according to the first preferred embodiment of the present invention.

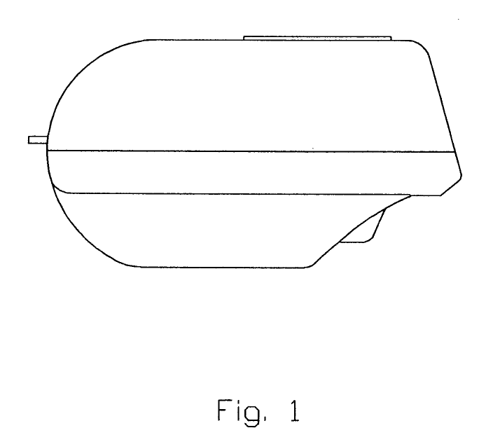

FIG. 2 is a vertical sectional view of the product shown in FIG. 1.

FIG. 3 is a cross sectional view of the product shown in FIG. 1.

FIG. 4 is a front view of the product shown in FIG. 1.

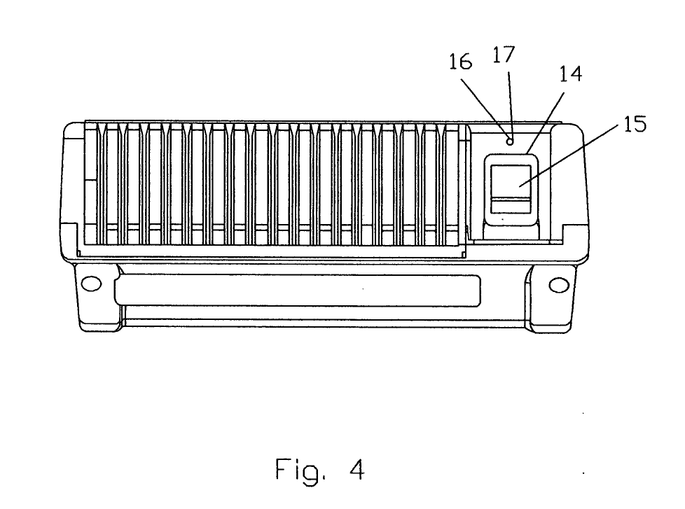

FIG. 5 is a back view of the product shown in FIG. 1.

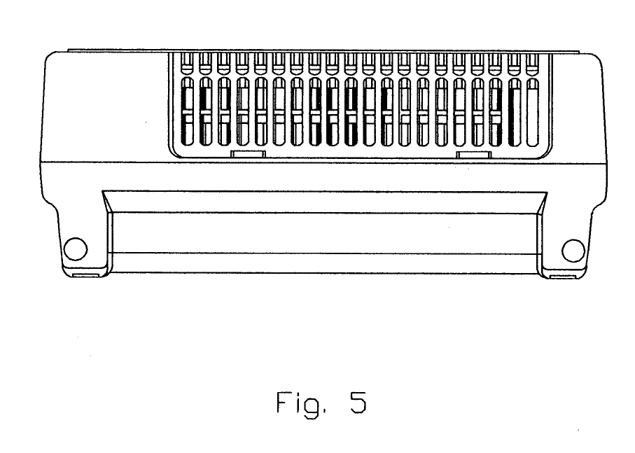

FIG. 6 is another side view of the product shown is FIG. 1.

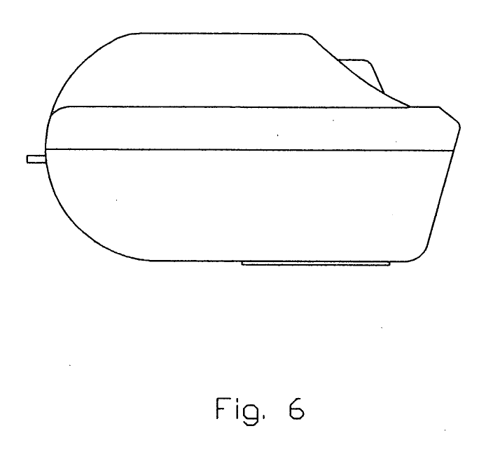

FIG. 7 is a top view of the product shown in FIG. 1.

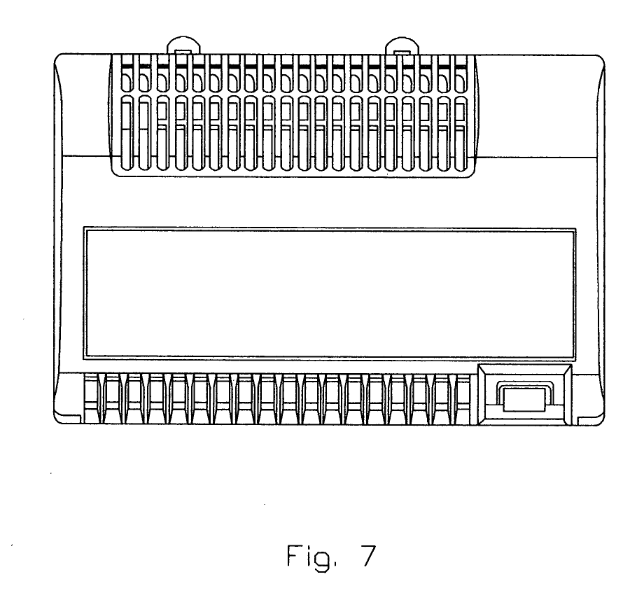

FIG. 8 is a bottom view of the product shown in FIG. 1.

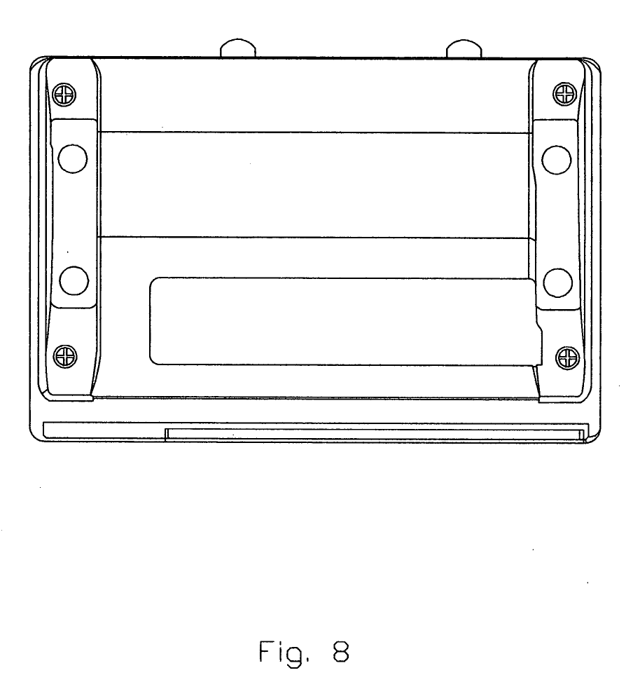

FIG. 9 is a side view of the product according to the second preferred embodiment of the present invention.

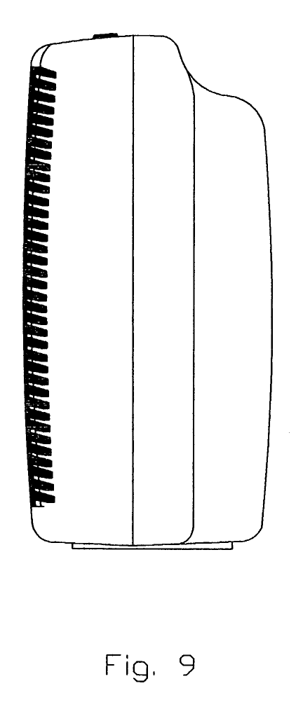

FIG. 10 is a sectional view of the product shown in FIG. 9.

FIG. 11 is a front view of the product shown in FIG. 9.

FIG. 12 is a back view of the product shown in FIG. 9.

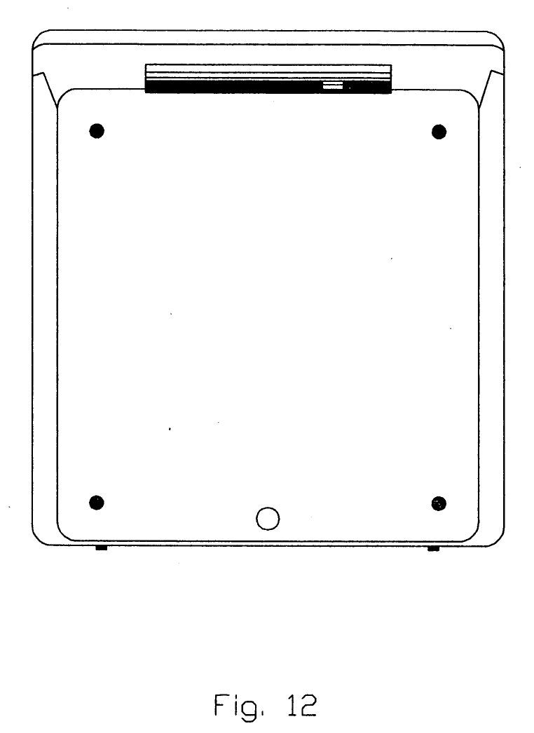

FIG. 13 is another side view of the product shown in FIG. 9.

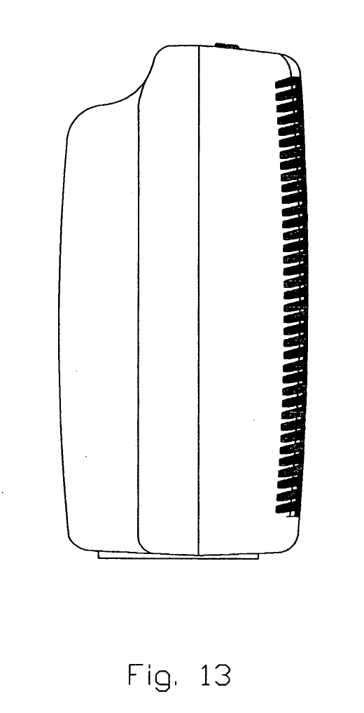

FIG. 14 is a top view of the product shown in FIG. 9.

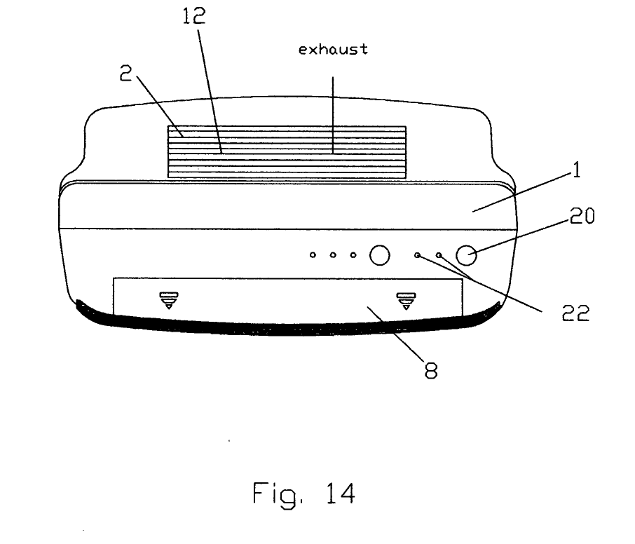

FIG. 15 is a bottom view of the product shown in FIG. 9.

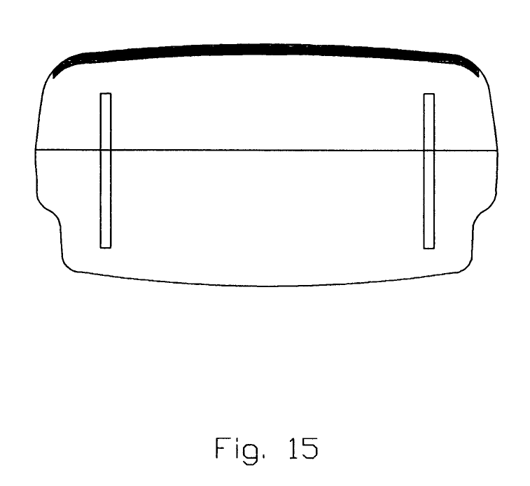

### DETAILED DESCRIPTION OF THE PREFERRED EMBODIMENT

A vehicular photoelectron air purifier of the first preferred embodiment of the present invention is a horizontal vehicular photoelectron air purifier, which mainly comprises a plurality rows of extractor fans, a plurality of polarization end ultraviolet ray radiation tubes and a plurality of air collecting walls. When air is drawn by said extractor fan into said horizontal vehicular photoelectron air purifier, it will ignite said polarization end ultraviolet ray radiation tube to radiate a polarization end ultraviolet ray which can eliminate virus, bacillus and mildew in the air that flows through said tube. Said horizontal vehicular photoelectron air purifier is equipped with one air inlet and one air outlet. Said polarization end ultraviolet ray radiation tube is mounted at said air inlet inside of said main body, while said extractor fan is fixed at said air outlet. When air containing virus, bacillus and mildew is drawn in the body through said air outlet, flowing air can easily enter and traverse through said air outlet, said flowing air can easily enter and traverse through said air intake frame trellis device of said horizontal vehicular photoelectron air purifier and then reach said air exhaust frame trellis device so that the air containing virus, bacillus and mildew must contact with said polarization end ultraviolet ray radiation tube and thus said polarization end ultraviolet ray eliminates virus, bacillus and mildew contained in the air.

Said horizontal vehicular photoelectron air purifier of this invention is light and convenient for user's carrying (a train or car plug is necessary) so that user can breathe in clean and fresh air free from virus, bacillus and mildew in various places, and thus the respiratory infectious disease can be effectively prevented.

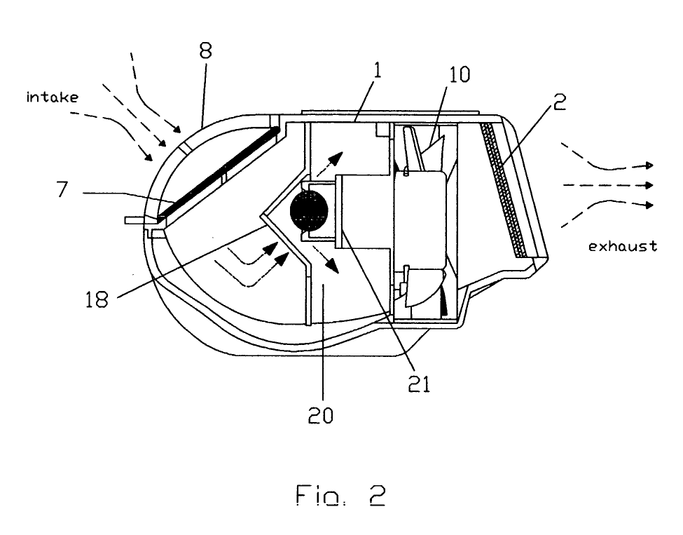

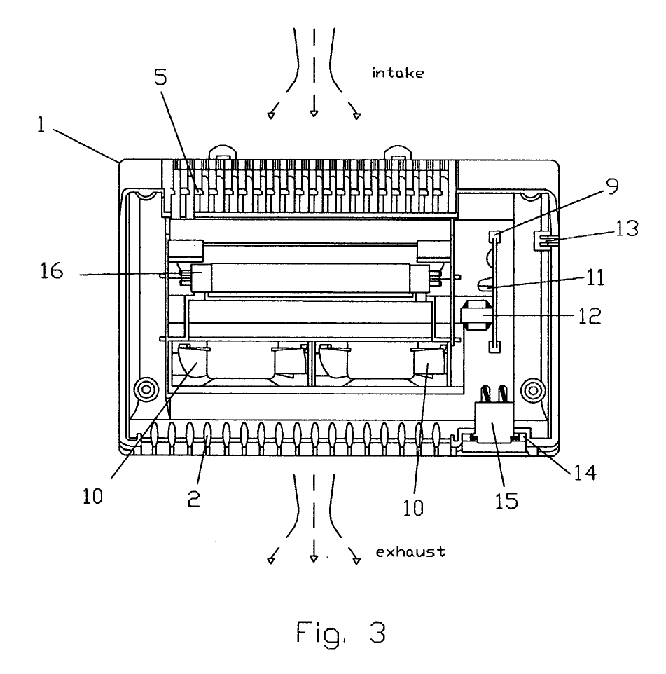

FIG. 2 and FIG. 3 show a detailed structure of said horizontal vehicular photoelectron air purifier. Said horizontal vehicular photoelectron air purifier has a main body 1 with square-columnar structure, and an air exhaust frame trellis device 2 is provided on a plane of a front portion of said body 1; air with the bacillus eliminated is exhausted through said air exhaust frame trellis device 2. A air intake frame trellis device 5 is provided at a rear portion of said body 1, which provides an air inlet and is used as a fixed dustproof frame 6, dustproof net 7 and dustproof cover 8; an extractor fan 10 is kept close to the inner surface of said air exhaust frame trellis device 2.

An electronic converter 11 is available on an upper part of a support frame 9 which is for protecting and fixing electronic generator of power supply; a power supply socket 13 is provided on side of said body 1 and provides a connection to a vehicular power supply or the municipal power supply to the user.

A quadrate hole 14 is provided at a front portion of said body 1 and is used for fixing a switch 15 that is for controlling functions of an extractor fan 10 and a polarization end ultraviolet ray radiation tube 16. There is a hole 16 above said switch 15, which is used for fixing LBDs 17 that is provided for indicating functions.

In practice, when said horizontal vehicular photoelectron air purifier is operated, air containing virus, bacillus and mildew is drawn by said extractor fan 10 into said air collecting wall 18 in said main body 1 through said dustproof net 7, so flowing air can easily enter said air collecting wall 18 and then reaches said air exhaust frame trellis device 2. Said polarization end ultraviolet ray radiation tube 16 is provided in a center portion of said air collecting wall 18; this means that when air containing virus, bacillus and mildew flows and enters said air collectors 18 and 19, and then enter into said air inlet 20 between said polarization end ultraviolet ray radiation tube 16 and said air collecting wall 19, said polarization end ultraviolet ray radiation tube 16 will radiate polarization end ultraviolet ray so as to eliminate virus, bacillus and mildew contained in the air; then purified clean and fresh air is, by said extractor fan 10, exhausted out of the air exhaust frame trellis device 2.

A sheltering walls 21 are provided at a front portion and a rear portion of said air collecting wall 18 for prohibiting user's eyes from injure by said polarization end ultraviolet ray radiating to the outside of said body 1.

An input power of the present invention is, through said switch 15 and through a full wave band rectifying circuit, supplied to the extractor fan via the speed control circuit, and operate a full wave rectifying circuit of said polarization end ultraviolet ray radiation tube 15 via a DC-AC converting circuit. This structure details of an electronic circuits in said horizontal vehicular photoelectron air purifier belongs to the prior art, therefore it is omitted here.

The second preferred embodiment of the present invention is a vertical vehicular photoelectron air purifier. It uses a polarization end ultraviolet ray radiation tube to radiate the polarization end ultraviolet ray which can eliminate virus, bacillus and mildew contained in the air flowing through the polarization end ultraviolet ray radiation tube, and meanwhile negative ion in the air is increased through the operation of the anion machine.

Said vertical vehicular photoelectron air purifier of the present invention comprises a plurality of extractor fans, a plurality of polarization end ultraviolet ray radiation tubes and a plurality of cathodal high-voltage discharging carbonized fiber wires. When air is drawn into said photoelectron air virus and bacillus eliminating device, two continuously alternating working modes are available; the first one is intermittent (about 3 to 4 minutes), said cathodal high-voltage output discharging via said carbonized fiber, ionized air produces negative ion and is exhausted through said fan; the other one is intermittent (about 7 to 10 minutes) igniting said polarization end ultraviolet ray radiation tube to radiate said polarization end ultraviolet ray which can eliminate virus, bacillus and mildew in the air that flows through said tube. Said photoelectron air purifier is equipped with one air inlet and one air outlet. Said cathodal high-voltage discharging fiber wire is mounted at said air outlet, said polarization end ultraviolet ray radiation tube is mounted at said air inlet in said body, and said fan is fixed at said air outlet in said body. When air containing virus, bacillus and mildew is drawn into said body through said air outlet, flowing air can easily enter and traverse through said air intake frame trellis device of said photoelectron air purifier and then reach said air exhaust frame trellis device so that air containing virus, bacillus and mildew must contact with said polarization end ultraviolet ray radiation tube and thus said polarization end ultraviolet ray eliminates virus, bacillus and mildew contained in air; then air is purified by the anion machine, and clean air containing the negative ion is exhausted out from said air outlet so as to improve indoor air quality.

The present invention has a square-columnar structure, with air inlet, extractor fan, polarization end ultraviolet ray radiation tube, and air outlet arranged vertically.

Said vertical vehicular photoelectron air purifier comprises a body 1 with a square-columnar structure, an air exhaust frame trellis device 2 with cambered surface structure is provided on rear upper portion of said body 1, an outer frame trellis device 4 is provided at the front portion of said body 1, and ionized air is exhausted through said air exhaust frame trellis device 2.

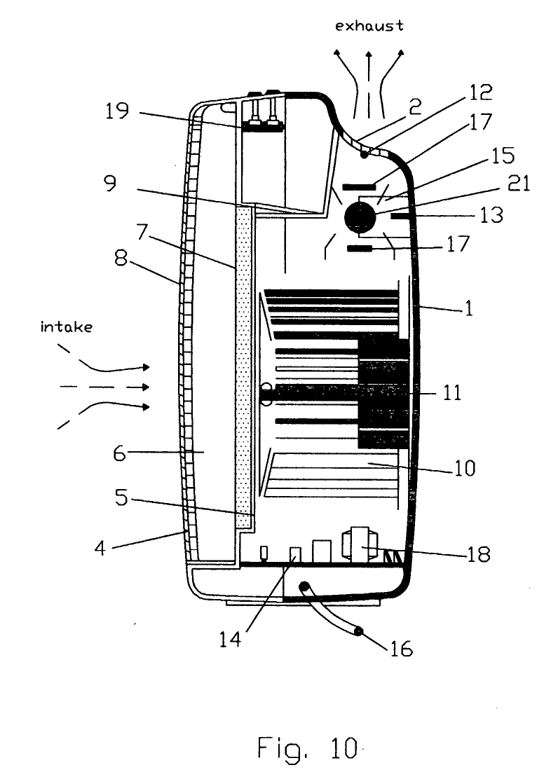

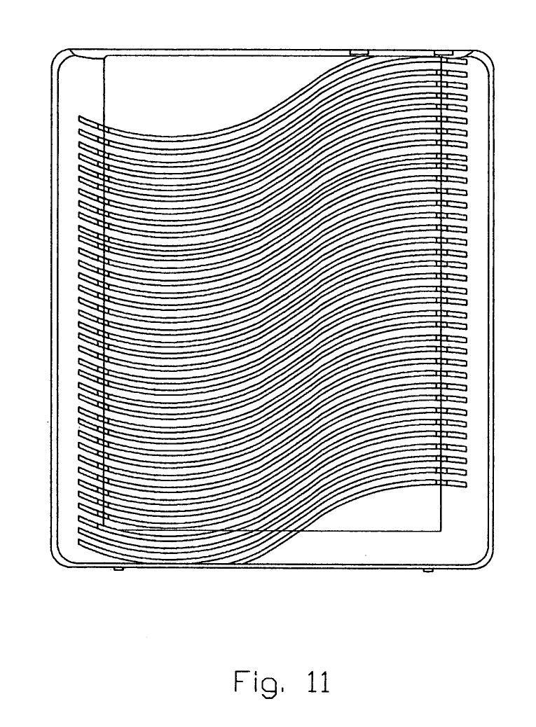

FIG. 10 and FIG. 11 show the detailed structure of said vertical vehicular photoelectron air purifier. An air intake frame trellis device 5 is provided at the front portion of said body 1, and provides an air inlet as a fixed dustproof frame 6, dustproof net 7 and dustproof cover 8; an extractor fan 10 and an electric motor 22 are kept close to a inner surface of said air intake frame trellis device 5, a carbonized fiber wire 23 is fixed in a center of a front surface of said air exhaust frame trellis device 2 and produces ionized air under said cathodal high voltage.

Positions are available in the body 1 for fixing the electronic generator 12, the electronic converter 11 and the power supply line 24.

Aquadrate hole 14 is provided at a upper surface of said body 1 for fixing a switch 15 that is for controlling functions of said electric motor 22, said extractor fan 10, said polarization and ultraviolet ray radiation tube 16 and said carbonized fiber wire 23. There are two holes 14 above said switch 15 for fixing LBDs 17 with different colors that are provided for indicating functions.

In practice, when said vertical vehicular photoelectron air purifier is operated, air containing virus, bacillus and mildew is drawn by said extractor fan 10 into said air collecting wall 18 (behind which there are many long grids) in said body 1 through said dustproof net 7, so flowing air can easily enter into said air collecting wall 18 and then reaches said air exhaust frame trellis device 2. Said polarization end ultraviolet ray radiation tube 16 is provided in a center of said air collecting wall 18; this means that when air containing virus, bacillus and mildew flows and enters said air collecting walls 18 and 19, and then enters into said air inlet 20 between said polarization end ultraviolet ray radiation tube 16 and said air collecting wall 19, said polarization end ultraviolet ray radiation tube 16 will radiate said polarization end ultraviolet ray so as to eliminate virus, bacillus and mildew contained in air; purified air is then drawn into said cathodal high-voltage discharging carbonized fiber wire 23 of said air exhaust frame trellis device 2 to produce negative ion, and said purified air containing the negative ion is exhausted out from said air exhaust frame trellis device 2 so as to improve indoor air quality.

A sheltering walls 21 are provided at the front and rear of said air collecting wall 18 and used for prohibiting user's eyes from injure by said polarization and ultraviolet ray radiating to the outside of said body 1.

An input power supply is provided to an anion high-voltage generating circuit through said switch 15, providing a negative high-voltage output. said input power supply is also supplied to said extractor fan 10 via a speed control circuit followed after a full wave band rectifying circuit, and operating a full wave rectifying circuit of said polarization end ultraviolet ray radiation tube 16 via a DC-AC converting circuit. Another input current, via a DC voltage-stabilizing circuit, is supplied to the automatic circulation control circuit of a anion generating circuit and an active circuit of said polarization end ultraviolet ray radiation tube 16 so as to control an alternative operation of a anion generating circuit and said polarization end ultraviolet ray radiation tube 16. Said anion high-voltage output of the electronic circuit system is available within a scope of 4.5 kv-8.5 kv. This control circuit belongs to the prior art, the detailed description is omitted here.

This potable photoelectric air virus and bacillus eliminating machine of the present invention uses a polarization end ultraviolet radiation ray tube to produce polarization end ultraviolet ray with wavelength of 253.7 nm. Scientific research proves that such ultraviolet ray can eliminate virus, bacillus and mildew contained in the air most effectively; negative ion in air can increased through operations of an anion machine so as to facilitate biochemical actions and reduce secretion of hormone that makes people feel weak and fatigue.

What is claimed is:

1. A vehicular photoelectron air purifier comprising:
a three-dimensional, square-columnar structure housing for actuating an assemblage having a plurality of air inlets and a plurality of air outlets with predetermined sharp, wherein the three-dimensional housing comprises:
at least two extractor fan mean horizontally inserted and engaged in said three-dimensional housing for mean of drawing air into said three-dimensional housing through said air inlet, through a ultraviolet radiation tube mean and out of said housing through said air outlet,
an air aggregator integrally provided between said extractor fan mean and said housing,
an ultraviolet radiation tube mean for generating ultraviolet rays to produce and increase the quantity of anions is integrally connected within said housing, said air inlet and air outlet are connected at both ends of said a ultraviolet radiation tube mean,
an electric circuit with a voltage transformer connected with an indicator light, a starter electrically connected via said electric circuit to said ultraviolet radiation tube,
a switch on said housing electrically connected via said electric circuit between said housing and said air drawing means, and a plug on an electric cord electrically connected to said electric circuit to engage with a wall socket to receive electricity therefrom;
a high negative voltage discharge/carbonated fiber is connected between said ultraviolet radiation tube and said air outlet.
an anion generating circuit and an ultraviolet radiation tube generating 253.7 nm start up circuit.
an air intake frame trellis device is provided at a rear portion of said body; an intake frame trellis device provides said air inlet and is used as a fixed dustproof frame, dustproof net and dustproof cover; said extractor fan is kept close to an inner surface of said air exhaust frame trellis device; there is an air collector between said air inlet and said extractor fan; said polarization end ultraviolet ray radiation tube lies in a center portion of said air collector.

2. As recited in claim 1, said vehicular photoelectron air purifier comprises at least two extractor fan arranged in said square-columnar body abreast along the linear direction of the polarization end ultraviolet ray radiation tube, wherein said air collector is composed of a space surrounded by an air collecting wall and a sheltering wall, and said polarization end ultraviolet ray radiation tube is fixed between a front and a rear portion of sheltering walls so that there is no light ray is radiated out of the purifier.

3. As recited in claim 1, said vehicular photoelectron air purifier, wherein a support frame is mounted on the side inside said body, an electronic converter and an electronic generator of power supply are provided at an upper end thereof; a power socket for connecting to a vehicular power supply or the municipal power is provided on side surface of said body.

4. As recited in claim 1, said vehicular photoelectron air purifier, wherein there is a quadrate hole on a front end surface of said body, in which a power supply switch for controlling said extractor fan and said polarization end ultraviolet ray radiation tube is arranged; there is a hole above said quadrate hole, in which, a LBDs for indicating functions is provided.

5. As recited in claim 1, said vehicular photoelectron air purifier, wherein, said body is in square-columnar structure comprising at least one extractor fan, transformer, at least one circuit board, at least a polarization end ultraviolet ray radiation tube, and a least one cathodal high-voltage discharging carbonized fiber wire. Said body is equipped with one air inlet and one air outlet; the air exhaust frame trellis device with cambered surface structure is provided on a rear upper portion of said body; an outer frame trellis device is provided at a front portion of said body; an air intake frame trellis device is provided at a rear portion of said outer frame trellis device; said intake frame trellis device provides an air inlet and is used as a fixed dustproof frame, dustproof net and dustproof cover; said cathodal high-voltage discharging carbonized fiber wire is fixed in a center portion of front surface of said air exhaust frame trellis device; said polarization end ultraviolet ray radiation tube is mounted at said air outlet in said body and lies in said air collector; said extractor fan and an electric motor are kept close to the inner surface of the air intake frame trellis device.

6. As recited in claim 1, said vehicular photoelectron air purifier, wherein said air collector is composed of a space surrounded by an air collecting wall and a sheltering wall, and said polarization end ultraviolet ray radiation tube is fixed between a front and a rear portion of said sheltering walls so that there is no light ray is radiated out of the purifier.

7. As recited in claim 5, said vehicular photoelectron air purifier, wherein said air collector is composed of a space surrounded by an air collecting wall and a sheltering wall, and said polarization end ultraviolet ray radiation tube is fixed between a front and a rear portion of said sheltering walls so that there is no light ray is radiated out of the purifier.

8. As recited in claim 1, said vehicular photoelectron air purifier, wherein there is an electronic converter, an electronic generator of power supply, and the power line are provided. At a lower portion in said body; a power socket for connecting to the vehicular power supply or the municipal power is provided on the side surface of the body.

9. As recited in claim 5, said vehicular photoelectron air purifier, wherein there is an electronic converter, an electronic generator of power supply, and the power line are provided. At a lower portion in said body; a power socket for connecting to the vehicular power supply or the municipal power is provided on the side surface of the body.

10. As recited in claim 1, said vehicular photoelectron air purifier, wherein there is a quadrate hole on the upper surface of said body, in which a power supply switch for controlling said electric motor, said extractor fan, said polarization end ultraviolet ray radiation tube and said carbonized fiber wire is mounted. There are two holes above said quadrate hole, by which two LBDs with different colors are fixed.

11. A vehicular photoelectron air purifier, the body of which is in square-columnar structure, in which comprising: extractor fan, transformer, circuit board, and polarization end ultraviolet ray radiation tube, it is characterized that the said body is equipped with one air inlet and one air outlet; the air outlet locates at the front of the body and an air exhaust frame trellis device is provided on the plane of the front end surface of the body; the air inlet locates at the front of the body and an air exhaust frame trellis device is provided on the plane of the front end surface of the body; the air inlet locates at the rear of the body and an air intake frame trellis device is provided at the rear end of the body; the intake frame trellis device provides an air inlet and is used as a fixed dustproof frame, dustproof net and dustproof cover; the extractor fan is kept close to the inner surface of the air exhaust frame trellis device; there is an air collector between the air inlet and the extractor fan; the polarization end ultraviolet ray radiation tube lies in the center of the air collector.
